(19) United States
(12) Patent Application Publication
(10) Pub. No.: US 2008/0297704 A1
(43) Pub. Date: Dec. 4, 2008

(54) LIQUID CRYSTAL DISPLAY PANEL AND MANUFACTURING METHOD THEREOF

(75) Inventor: YOSHIAKI HASHIMOTO, Kanagawa (JP)

Correspondence Address: YOUNG & THOMPSON, 209 Madison Street, Suite 500, ALEXANDRIA, VA, 22314, US

(73) Assignee: NEC LCD TECHNOLOGIES, LTD., KANAGAWA (JP)

(21) Appl. No.: 12/104,793

(22) Filed: Apr. 17, 2008

(30) Foreign Application Priority Data
Apr. 19, 2007 (JP) 2007-110192

(51) Int. Cl. G02F 1/1339; G02F 1/1335

(52) U.S. Cl. 349/106; 349/155; 349/190

(57) ABSTRACT

A liquid crystal display panel according to an exemplary aspect of the invention includes a pair of substrates, liquid crystal being arranged between the pair of substrates and spherical spacers being arranged between the pair of substrates. A partial area of at least one substrate of the pair of substrates is roughened, and each of the spherical spacers includes a plurality of projections on a surface thereof and is arranged on the roughened partial area.

### INCORPORATION BY REFERENCE

This application is based upon and claims the benefit of priority from Japanese Patent Application No. JP 2007-110192, filed on Apr. 19, 2007, the disclosure of which is incorporated herein in its entirety by reference.

### BACKGROUND OF THE INVENTION

1. Technical Field

The present invention relates to a liquid crystal display panel and a manufacturing method thereof, and in particular, to a liquid crystal display panel which includes spherical spacers interposed between a pair of substrates, and a manufacturing method thereof.

2. Background Art

A liquid crystal display device has been used widely as a display device of an AV (Audio Visual) apparatus and an OA (Office Automation) apparatus. The liquid crystal display device includes a liquid crystal display panel which includes liquid crystal interposed between a TFT (Thin Film Transistor) substrate in which a matrix of a plurality of switching elements such as TFT is formed, and a CF (color filter) substrate in which CF, black matrix (BM) or the like is formed. When a predetermined voltage is applied between the substrates of the liquid crystal display panel to generate an electric field, liquid crystal molecules are oriented and consequently light transmittance is controlled.

In order to improve display quality of the liquid crystal display panel (hereinafter, referred to as an LCD panel), it is important to control a distance (hereinafter, referred to as a gap) between the TFT substrate and the CF substrate. The gap is usually formed by spacers arranged between the substrates. For example, document 1 (Japanese Patent Application Laid-Open No. 2003-121859) discloses an LCD panel which includes columnar spacers interposed between the substrates.

FIG. 14 shows a fragmentary cross sectional view of the LCD panel disclosed in document 1. In FIG. 14, the columnar spacer is arranged between the TFT substrate and the CF substrate of the LCD panel. Because the columnar spacer is fixed between the substrates, the gap between the substrates is kept uniform and stable. Moreover, since the columnar spacer hardly slides in a space between the substrates, high contrast can be obtained continuously when the columnar spacers are arranged in a light shielding area on manufacturing.

However, elasticity of the columnar spacer is generally small. Therefore, when volume of the liquid crystal varies with temperature change, the columnar spacer can not absorb the volume change. As a result, luminance non-uniformity is generated. The columnar spacer is arranged between the substrates, while being usually compressed by several percent. That is, the columnar spacer is always kept compressed. Even if external stress to the columnar spacer disappears, it is difficult for the columnar spacer to perfectly restore an initial size thereof. When the external stress is applied to the LCD panel while a screen thereof indicates black, distortion due to the external stress is kept between the substrates even after disappearance of the external stress. Consequently, haze (hereinafter, referred to as black haze) is generated temporarily in the screen of the LCD panel.

In recent years, the LCD panel tends to have narrower gap. Then, the use of the columnar spacer may raise risk of generating the display problems, like luminance non-uniformity and the black haze.

Thus, the LCD panel in which the gap is formed by spherical spacers instead of the columnar spacers is proposed. Because the spherical spacer is more elastic than the columnar spacer, when volume of the liquid crystal varies with temperature change, the spherical spacer can absorb the volume change. Consequently, the luminance non-uniformity does not occur. The spherical spacer can quickly restore the initial size after disappearance of the external stress. Accordingly, the black haze due to remaining distortion does not occur.

Moreover, because the spherical spacer is not firmly fixed on the substrate differently from the columnar spacer, the spherical spacer may work like a ball bearing between the substrates. Accordingly, the occurring of the black haze or the like can be prevented when the external stress in a direction parallel to a surface of the LCD panel, for example the force to rub the LCD panel, is applied.

On the other hand, because the spherical spacer is not firmly fixed on the substrate, the spherical spacer slides easily due to vibration or the like during transportation of the LCD panel. When the spherical spacer slides to a display area, contrast thereof decreases.

Then, each of document 2 (Japanese Patent Application Laid-Open No. 2000-235188), document 3 (Japanese Patent Application Laid-Open No. 1988-78131) and document 4 (Japanese Patent Application Laid-Open No. 2003-5196) discloses a LCD panel that can prevent a spherical spacer from easily sliding to the display area of the LCD panel.

The LCD panel disclosed in document 2 includes the spherical spacers which are arranged in concave parts formed in a light shielding area. FIG. 15 shows a fragmentary cross sectional view of the LCD panel disclosed in document 2. In FIG. 15, being arranged in the concave part formed in the CF substrate, each of the spherical spacers does not slide easily to the display area. Accordingly, the LCD panel disclosed in document 2 can prevent generation of the luminance non-uniformity and the black haze, and moreover, can prevent degradation of the contrast due to the spherical spacer moving in the display area.

Document 3 discloses the LCD panel which includes the spherical spacers each having a rough surface between the substrates. The spherical spacer with the rough surface is held on the substrate. Accordingly, the LCD panel disclosed in document 3 can prevent generation of the luminance non-uniformity and the black haze, and moreover, can prevent degradation of contrast due to the spherical spacer moving in the display area. Meanwhile, document 4 discloses that one substrate of the LCD panel includes an rough area having contact with the spherical spacer in order to secure good electric connection between the substrates.

### SUMMARY

An exemplary object of the present invention is to provide a liquid crystal display panel and a manufacturing method thereof which can prevent display problems, like luminance non-uniformity, black haze, and degradation of contrast.

A liquid crystal display panel according to an exemplary aspect of the invention includes a pair of substrates, liquid crystal being arranged between the pair of substrates and spherical spacers being arranged between the pair of substrates. A partial area of at least one substrate of the pair of substrates is roughened, and each of the spherical spacers includes a plurality of projections on a surface thereof and is arranged on the roughened partial area.

A method for manufacturing a liquid crystal panel in which liquid crystal and spherical spacers are arranged between a pair of substrates of a first substrate and a second substrate according to an exemplary aspect of the invention includes mixing a solution with the spherical spacers each having a plurality of projections exposing a partial area of a layer of resin formed on the first substrate in He plasma atmosphere for roughening a surface of the partial area applying the solution to the surface of the partial area having been roughened and evaporating the solution by heat and forming a sealing part on the first substrate and overlapping the second substrate on the first substrate while dropping the liquid crystal therebetween.

### BRIEF DESCRIPTION OF THE DRAWINGS

Exemplary features and advantages of the present invention will become apparent from the following detailed description when taken with the accompanying drawings in which:

FIG. 1 is a fragmentary top view showing structure of a TFT substrate of an LCD panel according to a first exemplary embodiment of the present invention;

FIG. 2 is a fragmentary top view showing structure of a CF substrate of the LCD panel according to the first exemplary embodiment of the present invention;

FIG. 3 is a fragmentary cross sectional view showing structure of the LCD panel according to the first exemplary embodiment of the present invention;

FIG. 4 illustrates a manufacturing process of the LCD panel according to the first exemplary embodiment of the present invention;

FIG. 5 illustrates surface roughness of the substrate according to the first exemplary embodiment of the present invention;

FIG. 6 illustrates surface roughness of a spherical spacer according to the first exemplary embodiment of the present invention;

FIG. 7 is a fragmentary cross sectional view showing structure of another LCD panel according to the first exemplary embodiment of the present invention;

FIG. 8 is a fragmentary top view showing structure of a CF substrate of an LCD panel according to a second exemplary embodiment of the present invention;

FIG. 9 is a fragmentary cross sectional view showing structure of the LCD panel according to the second exemplary embodiment of the present invention;

FIG. 10 is a fragmentary cross sectional view showing structure of an LCD panel according to a third exemplary embodiment of the present invention;

FIG. 11 is a fragmentary cross sectional view showing structure of an LCD panel according to a fourth exemplary embodiment of the present invention;

FIG. 12 is a fragmentary cross sectional view showing structure of an LCD panel according to a fifth exemplary embodiment of the present invention;

FIG. 13 is a fragmentary cross sectional view showing a manufacturing process of the TFT substrate according to the fifth exemplary embodiment of the present invention;

FIG. 14 is a fragmentary cross sectional view showing structure of an LCD panel according to document 1; and

FIG. 15 is a fragmentary cross sectional view showing structure of an LCD panel according to document 2.

### EXEMPLARY EMBODIMENT

Exemplary embodiments of the present invention will now be described in detail in accordance with the accompanying drawings.

### The First Exemplary Embodiment

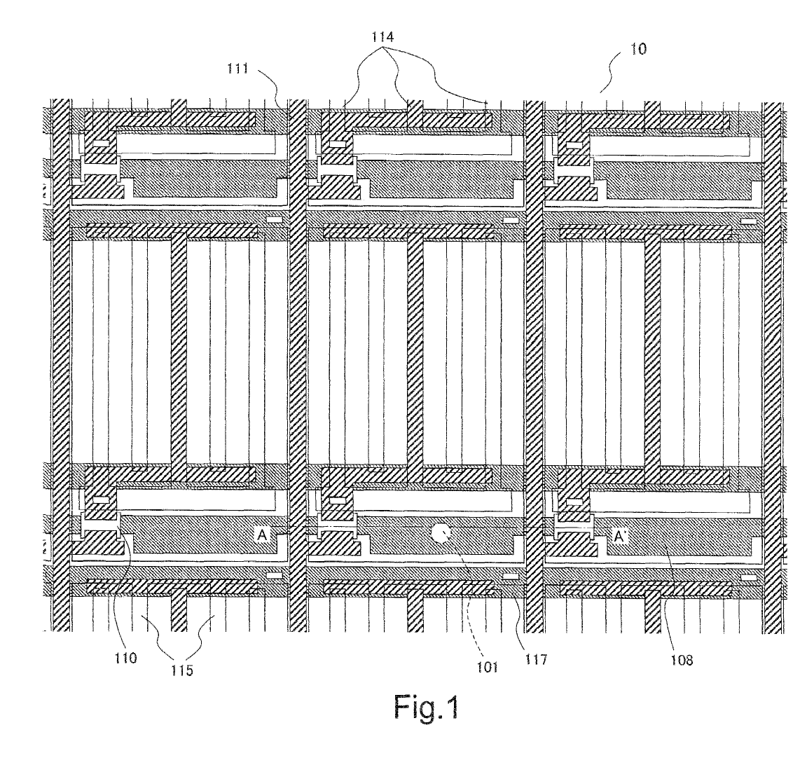

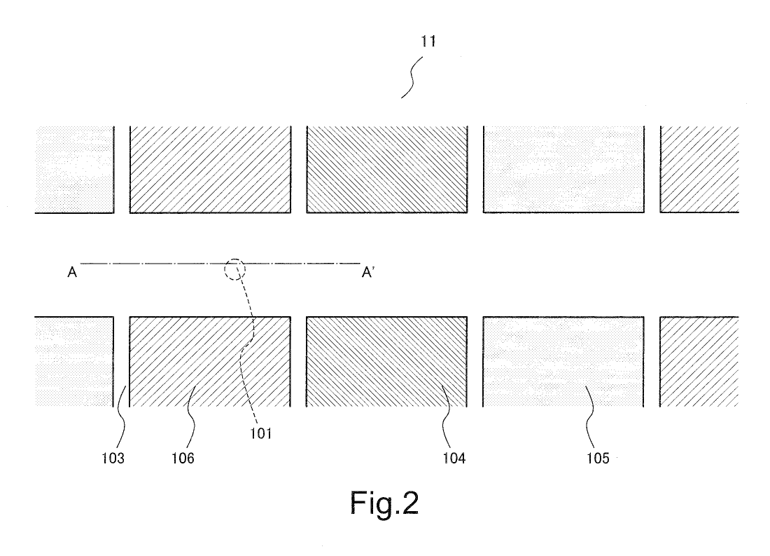

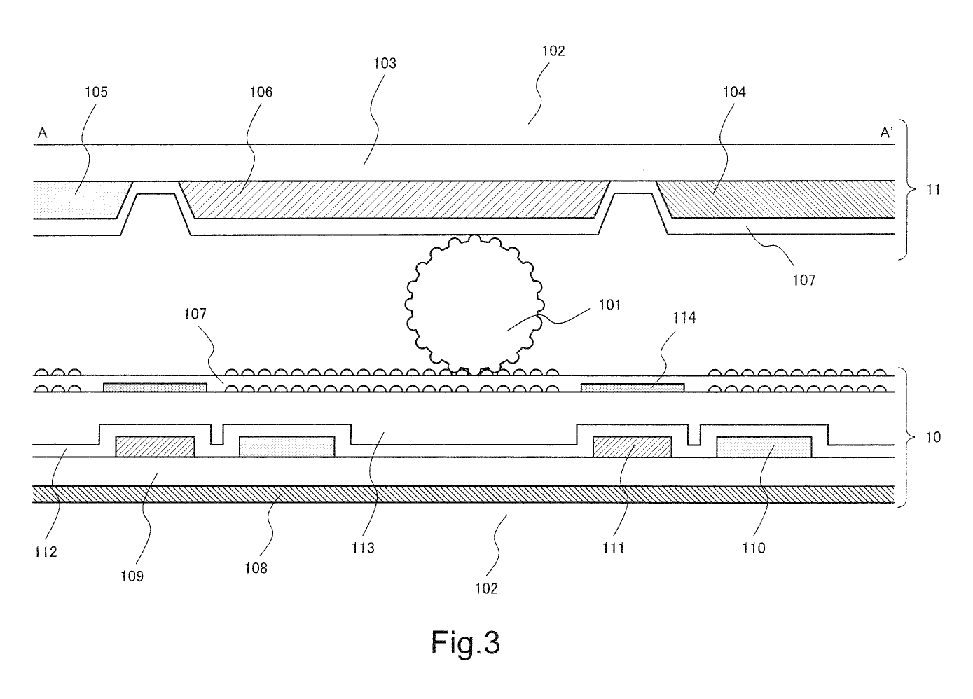

An LCD panel according to a first exemplary embodiment of the present invention will be described with reference to FIG. 1 to FIG. 3. FIG. 1 is a fragmentary top view showing structure of a TFT substrate 10, and FIG. 2 is a fragmentary top view showing structure of a CF substrate 11 according to the embodiment. FIG. 3 is a cross sectional view showing structure of the LCD panel, taken along A-A′ line in FIG. 1 and FIG. 2.

In FIG. 3, a spherical spacer 101 with surface having a plurality of projections is arranged between the TFT substrate 10 and the CF substrate 11. A surface of a contact area of the TFT substrate 10 having contact with the spherical spacer 101 is roughened.

Hereinafter, the TFT substrate 10, the CF substrate 11 and the spherical spacer 101 will be described in detail. First, the TFT substrate 10 will be described with reference to FIG. 1 and FIG. 3. The TFT substrate 10 includes a transparent insulating substrate 102 which is made of glass, plastic or the like (hereinafter, referred to as a glass substrate 102). The glass substrate 102 includes a gate electrode, a gate wiring line 108 and a common wiring line 117 thereon. The surface of the glass substrate 102 on which surface the gate electrode, the gate wiring line 108 and the common wiring line 117 are arranged is covered with a gate insulating layer 109 made of silicon oxynitride.

Moreover, a plurality of semiconductor layers 110 connecting to the gate electrode, a plurality of drain wiring lines 111 connecting to source electrodes, and a plurality of drain electrodes are formed on the gate insulating layer 109. The elements above are covered with a passivation film 112 made of silicon nitride, and a planarizing layer 113 made of an acrylic resin or the like. Further, at least partial area of the surface of the planarizing layer 113 having contact with the spherical spacer 101 is roughened.

A plurality of pixel electrodes 114 and a plurality of opposed electrodes 115 (not appearing in the FIG. 3) are formed in the other area of the planarizing layer 113 with non-roughened surface. The pixel electrodes 114 are connected to the drain electrode via contact holes which penetrate the passivation film 112 and the planarizing layer 113. The opposed electrodes 115 are connected to the common wiring lines 117 via contact holes which penetrate the gate insulating layer 109, the passivation film 112 and the planarizing layer 113. An alignment film 107 made of polyimide is formed so as to cover the pixel electrodes 114, the opposed electrodes 115, and the planarizing layer 113.

The CF substrate 11 will be described with reference to FIG. 2 and FIG. 3 in the following. The CF substrate 11 includes black matrix 103 formed on the glass substrate 102 which is made of glass, plastic or the like. Each of color layers 104 to 106 is formed in an area on the glass substrate 102 where the black matrix 103 is not formed so that a part of each the color layers 104 to 106 may overlap with the black matrix 103. Here, the color layers 104, the color layers 105, and the color layers 106 are in red, green, and blue respectively.

Next, the spherical spacer 101 will be described with reference to FIG. 1 to FIG. 3. A polymer bead mainly made of styrene and siloxane is used for the spherical spacer 101 according to the first exemplary embodiment of the present invention. As shown in FIG. 3, a plurality of projections are formed on a surface of the spherical spacer 101. Surface roughness and diameter of the spherical spacer 101 are set to be about 200 nm and 4 μm respectively. Description on the surface roughness will be described later.

The spherical spacer 101 with surface having a plurality of projections is arranged in a light shielding area near one of the blue display areas between the TFT substrate 10 and the CF substrate 11. That is, the spherical spacer 101 is arranged in an area of the black matrix 103 between the color layers 106, as shown in FIG. 2, since the blue display area has the lowest visibility among the red, the blue and the green display areas. Since the spherical spacer 101 is arranged in the light shielding area near the display area for a color layer having the lowest visibility, it is difficult for the spherical spacer 101 to be visually recognized even if the spherical spacer 101 is placed in the display area by accident. Accordingly, possibility of display fault of the LCD panel can be reduced.

Further, while one spherical spacer 101 is arranged in an area of the black matrix 103 between the color layers 106 in FIGS. 1 to 3, a plurality of spherical spacers 101 may be arranged therein.

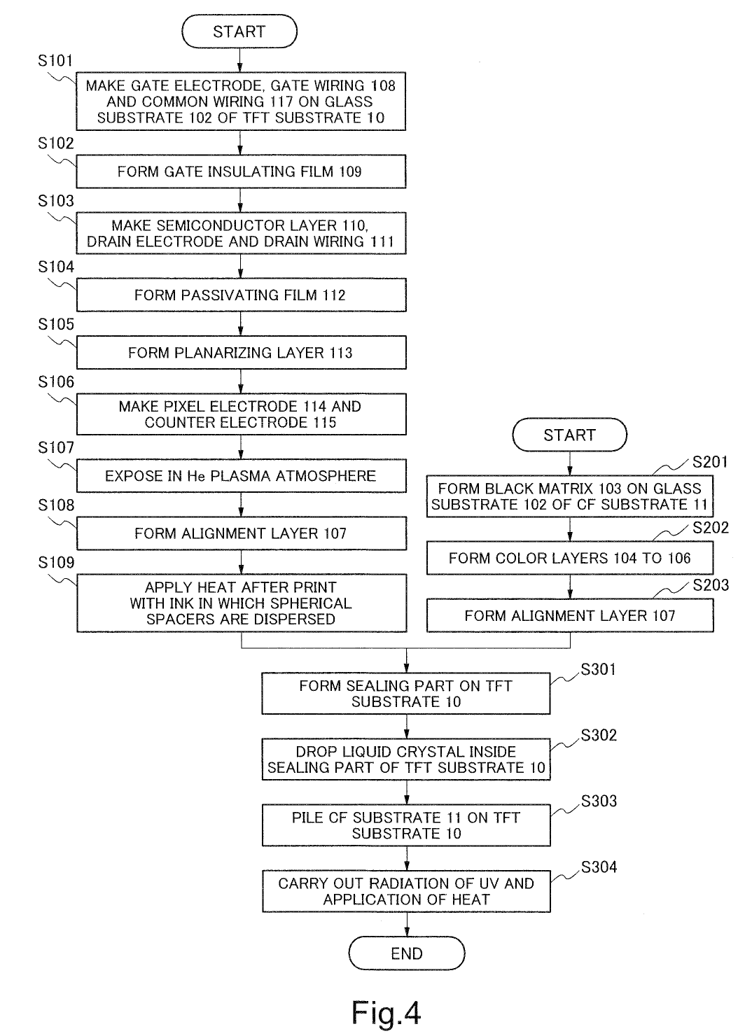

Next, a process for manufacturing the LCD panel according to the first exemplary embodiment will be described with reference to FIG. 4. In FIG. 4, as a first step, a layer made of a first conductive material is formed on the top surface of the glass substrate 102 of the TFT substrate 10, and subsequently, the gate electrode, the gate wiring line 108 and the common wiring line 117 are made with the photolithography method (S101). Then, the gate insulating layer 109 is formed with silicon oxynitride to cover the electrode and wiring lines above (S102).

After forming amorphous silicon layer or poly silicon layer on the gate insulating layer 109, the island-shaped semiconductor layers 110 are formed byprocessing the layer with the photolithography method. Similarly, a second conductive material layer is formed on the gate insulating layer 109, and the drain electrode and the drain wiring line 111 are formed with the photolithography method (S103).

Then, the passivation film 112 is formed with silicon nitride on the drain electrode and drain wiring line 111 (S104), and the planalizing layer 113 made of a photosensitive acrylic resin covers the passivation film 112 (S105).

Next, contact holes which reach the drain electrode and COM electrode through penetrating the planarizing layer 113 are made with the photolithographymethod. Afterward, a transparent conductive layer is formed over the planarizing layer 113, and the pixel electrodes 114 and the opposed electrodes 115 are formed with the photolithography method (S106). Moreover, a resist layer is formed on a non-roughened area of the planarizing layer 113, and the planarizing layer 113 is exposed in He plasma atmosphere so that a desired area of the planarizing layer 113 becomes rough (S107). Afterward, an alignment film 107 made of polyimide is formed on the planarizing layer 113, and then a process for orientation is carried out (S108).

The passivation film 112 is made of silicon nitride, and the planarizing layer 113 is made of acrylic resin according to the first exemplary embodiment. The passivation film 112 may be made of either silicon oxynitride or silicon oxide, and the planarizing layer 113 may be made of either styrene-based resin or novolac resin.

Moreover, the planarizing layer 113 is roughened so that the surface roughness of the alignment film 107 formed thereon may be about 200 nm according to the first exemplary embodiment. A method of roughening a whole area of the planarizing layer 113 may also be applicable to the embodiment in stead of the method of roughening a partial area of the planarizing layer 113 where the spherical spacer is arranged.

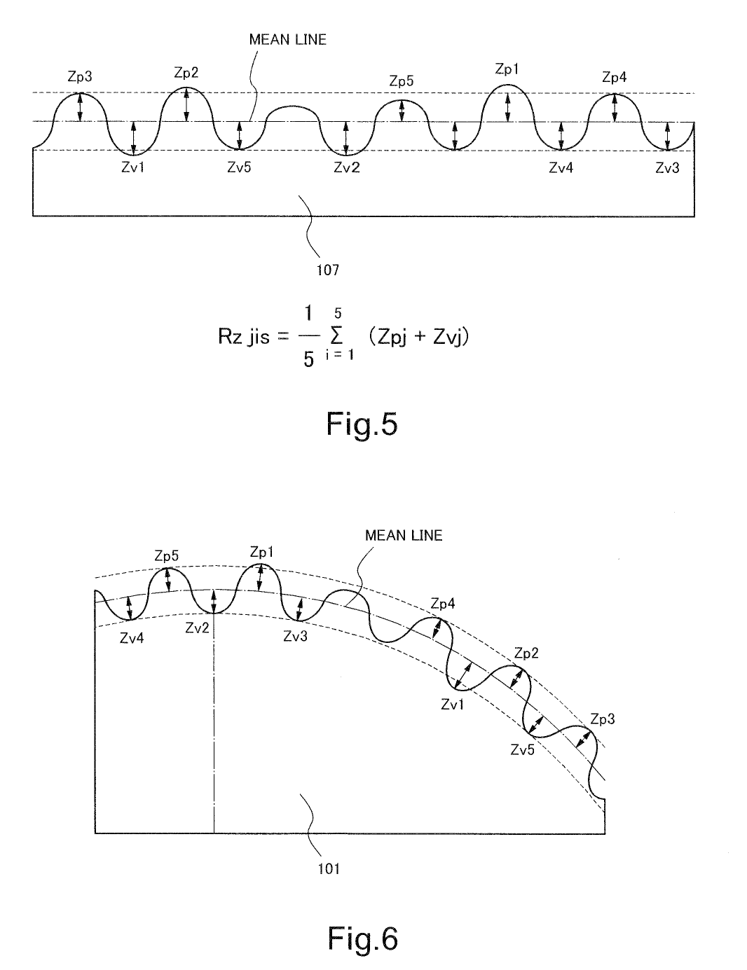

Here, roughness of surfaces of the TFT substrate 10 and the spherical spacer 101 are quantified with the so-called ten point height of roughness profile method specified by JIS B0601 (Japanese Industrial Standard B0601). A method to quantify the surface roughness of the TFT substrate 10 and the spherical spacer 101 with the ten point height of roughness profile method will be described with reference to FIG. 5 and FIG. 6. First, a mean line of the roughness regarding a predetermined part is calculated. Second, top 5 profile peaks in the order of height and bottom 5 profile valleys in the order of depth are selected based on the mean line. Then, the average of 5 profile peaks and 5 profile valleys is defined as the ten point height of roughness profile. That is, the surface roughness Rz is represented by an equation (1) described below.

$$Rz - 1 / 5 {\sum }_{i - 1}^{5} ( Zpi + Zvi ) \qquad ( 1 )$$

where Zpi denotes height of the i-th profile peak and Zvi denotes i-th profile valley.

The process for manufacturing the LCD panel is further described below. The spherical spacers with surface having a plurality of projections are dispersed in solution of low-boiling-alcohol-based ink in advance. Then, the ink including the spherical spacers is printed on the rough area of the alignment film 107 of the TFT substrate 10 with an ink jet method. Moreover, the TFT substrate 10 on which the ink is printed is heated to evaporate the ink solution. As a result, the spherical spacers are arranged at a predetermined position (s109).

Because a surface of the TFT substrate 10 on which the spherical spacers are arranged is roughened, a wettability of the roughened surface is remarkably high in comparison with that of a surface of the TFT substrate 10 which is not roughened. Accordingly, positional accuracy of the printing remarkably improves, when the printing by the ink jet method using the ink including the spherical spacers is performed on the predetermined position of the TFT substrate 10.

Here, the spherical spacers are dispersed in the solution of low-boiling alcohol in the first exemplary embodiment. As the solution of low-boiling alcohol, a lower alcohol whose carbon number is not larger than 4, for example ethanol, methanol, propanol and isopropanol, and mixed solvents thereof can be used. A material in which the spherical spacer is hardly soluble and which is evaporated completely at a temperature not higher than 200 degrees C. can be used for the solution for dispersing the spherical spacers therein. The method for printing the spherical spacers is not limited to the ink jet method. Other method, for example, the intaglio printing method or the like is also applicable.

Meanwhile, the CF substrate 11 is formed as follows. That is, the black matrix 103 is formed in the light shielding area of the glass substrate 102 (S201). The color layers 104 to 106 are formed with resin in an opening area of the glass substrate 102 on which the black matrix 103 is not formed (S202). The alignment film 107 is formed with polyimide on the black matrix 103 and the color layers 104 to 106, and then, a process for orientation of the alignment film 107 is carried out (S203).

Moreover, liquid crystal is interposed between the TFT substrate 10 and the CF substrate 11 which are formed as mentioned above. In the first exemplary embodiment, after forming a sealing part made of an UV heat-curable sealing material on the TFT substrate 10 (S301), the liquid crystal is dropped on the TFT substrate 10 (S302). Moreover, the CF substrate 11 is overlapped on the TFT substrate 10 on which the liquid crystal is dropped with high accuracy by a vacuum overlapping apparatus (S303). When an UV radiating process and a heating process for UV heat-curable sealing material are carried out in such configuration, the substrates are sealed by hardened UV heat-curable sealing material (S304). Then, the LCD panel is manufactured completely.

The LCD panel manufactured in the method as mentioned above can prevent the luminance non-uniformity due to volume change of the liquid crystal and the black haze due to residual external stress being generated, because the spherical spacers are used to make the gap between the substrates.

Moreover, it is possible to restrain substantially the spherical spacer from moving, because both of the surface of the spherical spacer 101 and the partial area of the TFT substrate 10 having contact with the spherical spacer 101 are rough. Accordingly, it is possible to prevent degradation of contrast due to the spherical spacer moving to the display area.

Here, in the first exemplary embodiment, while the surface roughness of the spherical spacer 101 and the TFT substrate 10 are set to be about 200 nm, the surface roughness of the spherical spacer 101 and the TFT substrate 10 are not limited to the values. The surface roughness can be set appropriately according to size, compressibility or the like of the spherical spacer 101. In order to restrain substantially the spherical spacer from moving, it is desirable to set each surface roughness of the spherical spacer 101 and the TFT substrate 10 to be not smaller than 50 nm. Hereinafter, a reason why the surface roughness is set to be not smaller than 50 nm will be described in the following.

Frictional force F between two solids whose surfaces touch each other is represented as

F=τAr

where Ar denotes effective contact area and τ denotes shear strength of the contact area. Because the effective contact area Ar of the spherical spacer becomes broad according to a ratio of the surface roughness, the frictional force F is proportional to the ratio of the surface roughness. Because the surface roughness of the spherical spacer with non-roughened surface is supposed to be not larger than 20 nm, the frictional force may be more than 2.5 times larger than that of the surface roughness of 20 nm if the spherical spacer having the surface roughness of about 50 nm is used.

Meanwhile, it is necessary to use the spherical spacer within a compression rate in which the spherical spacer 101 elastically deform in order to prevent the luminance non-uniformity due to change of volume of the liquid crystal, and the black haze due to the residual external stress. The spherical spacer 101 made of a usual polymer bead which is mainly made of styrene and siloxane can be kept elastic, if the compression rate thereof is not more than 15 percent at a room temperature. Moreover, volume of the usual liquid crystal material changes by 3 to 4 percent according to change of temperature by ±40 degrees C. In consideration of change of volume of the liquid crystal material due to change of temperature of a product including the liquid crystal material, it is desirable to design the spherical spacer arranged between the substrates so as to make the compression rate at the room temperature ranged from 5 to 11 percent.

When the spherical spacer is compressed by u percent of diameter thereof, the contact area of the spherical spacer is equal to an half of cross sectional area which is obtained by cutting in round slice of the spherical spacer at the position apart from top of the spherical spacer by μ percent. “The compression of the spherical spacer by μ percent” means that a distance from center of the spherical spacer to surface of the substrate is (100−μ)/2 percent of diameter of the spacer.

It is desirable to use the spherical spacer within the compression rate ranged from 5 to 11 percent as mentioned above. In comparison of the spherical spacer compressed by 11 percent with the spherical spacer compressed by 5 percent, the contact area of the former spherical spacer is about 2.13 times ((1−0.89²)/(1−0.95²)=2.13) as broad as that of the latter spherical spacer.

That is, the frictional force which is caused when the spherical spacer with 20 nm-roughness surface is compressed by 11 percent is equal to the frictional force which is caused when the spherical spacer with 43 nm-roughness surface (2.13 times as long as 20 nm) is compressed by 5 percent. Accordingly, when the spherical spacer with 50 nm-roughness surface is used, the frictional force is larger than the frictional force which is caused when the spherical spacer which is not rough (surface roughness is 20 nm) is compressed at a maximum.

For reference, the frictional force caused when the spherical spacer with 50 nm-roughness surface is compressed by 11 percent is about 5.3 times (2.13 times×2.5 times) as large as the frictional force caused when the spherical spacer with non-roughened surface (surface roughness is 20 nm) is compressed by 5 percent.

Next, influence which the spherical spacer with the rough surface exerts on uniformity of the gap between the substrates will be described. Change of light transmittance of the uniaxial liquid crystal material sandwiched between polarizers is almost proportional to change of the gap. Because allowable variation in brightness of an apparatus is generally about 2 to 5 percent, allowable change of the gap is also about 2 to 5 percent.

When the spherical spacer is compressed, the compressed spherical spacer may be equivalent to a spherical spacer with a soft surface because the projection formed on the surface of the spherical spacer is easily deformed. In other words, the spherical spacer with excessively high projections can not keep the gap constant. As a result, change of the gap causes variation in brightness being generated. Accordingly, it is desirable to keep a height of the projection smaller than an amount of deformation of the spherical spacer due to the compression.

When the spherical spacer is used in a range of the compression rate thereof ranges from 5 to 11 percent, it is desirable that the surface roughness of the spherical spacer is not larger than 5.5 percent (the surface roughness is 11/2 (5.5) percent, because there are arranged on the TFT substrate and the CF substrate) of diameter of the spherical spacer. If a diameter of the spherical spacer is 4 μm, it is desirable to set the surface roughness of the spherical spacer to be not larger than 220 nm.

The LCD panel and the method for manufacturing thereof according to the first exemplary embodiment adopt the spherical spacer 101 in order to make the gap between the substrates. When volume of the liquid crystal increases due to change of temperature, it is possible to prevent generation of the luminance non-uniformity in the LCD panel through the spherical spacer being squashed. When the LCD panel is released from the external stress, it is possible to prevent generation of the black haze through the spherical spacer being restored to the initial size quickly.

Moreover, according to the LCD panel and the method for manufacturing thereof of the first exemplary embodiment, both the surface of the spherical spacer 101 and the partial area of the TFT substrate 10 having contact with the spherical spacer 101 are roughened. The frictional force caused when both the surface of the spherical spacer 101 and the TFT substrate 10 are rough is several times as large as the frictional force caused when the spherical spacer and the substrate are not rough. As a result, the spherical spacer 101 can be restrained substantially from moving and it is possible to prevent degradation of contrast.

Here, according to the first exemplary embodiment, volume of the liquid crystal is adjusted so that the spherical spacer 101 is compressed by about 0.2 μm at the room temperature in order not to generate the luminance non-uniformity even if volume of the liquid crystal changes as temperature changes.

Ink including the spherical spacers by about 2 percent by weight is used to print the spherical spacers on the TFT substrate 10. When the ink of several drops is dropped on the TFT substrate 10 at the rate of 10 pl/drop, about four spherical spacers on average are arranged on the TFT substrate 10. Because the spherical spacers assemble near a center of the droplet as the ink dries, it is desirable that the area of the light shielding area of the black matrix 103 is more than a square area of 40 μm.

While the partial area of the TFT substrate 10 having contact with the spherical spacer 101 is roughened as mentioned above, the partial area of the CF substrate 11 having contact with the spherical spacer 101 may be roughened. It is possible to make an area of the CF substrate 11 rough by exposing a surface of the resin in the He plasma atmosphere.

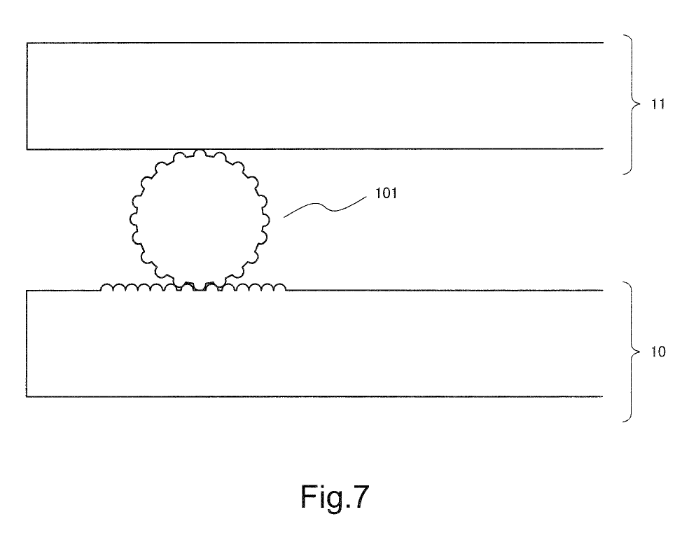

FIG. 7 shows the LCD panel having minimum elements according to the first exemplary embodiment. In FIG. 7, the LCD panel includes a TFT substrate 10, a CF substrate 11 and a spherical spacer 101. The partial area of the TFT substrate 10 having contact with the spherical spacer 101 is roughened by exposure in the He plasma atmosphere. Meanwhile, the spherical spacer 101 includes a plurality of projections of 50 nm or over height on a surface thereof.

When both the spherical spacer 101 and one of the substrates are roughened, it is possible to restrain the spherical spacer 101 from moving substantially and to provide the LCD panel which can prevent degradation of contrast.

### The Second Exemplary Embodiment

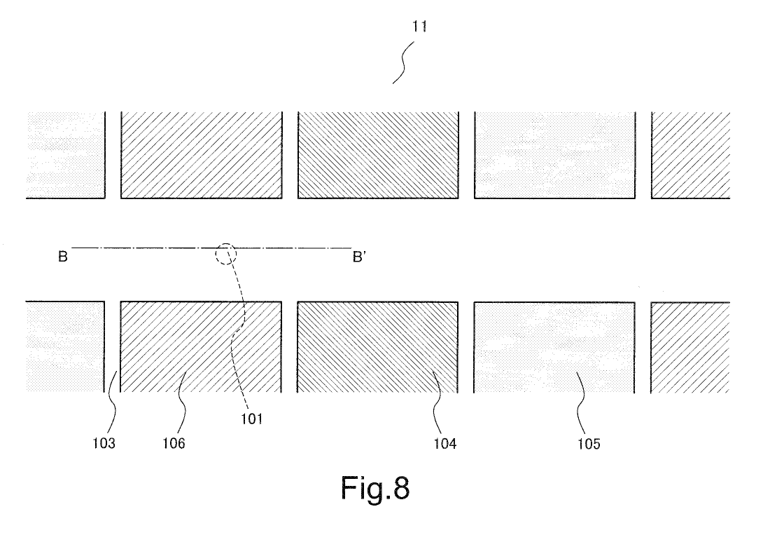

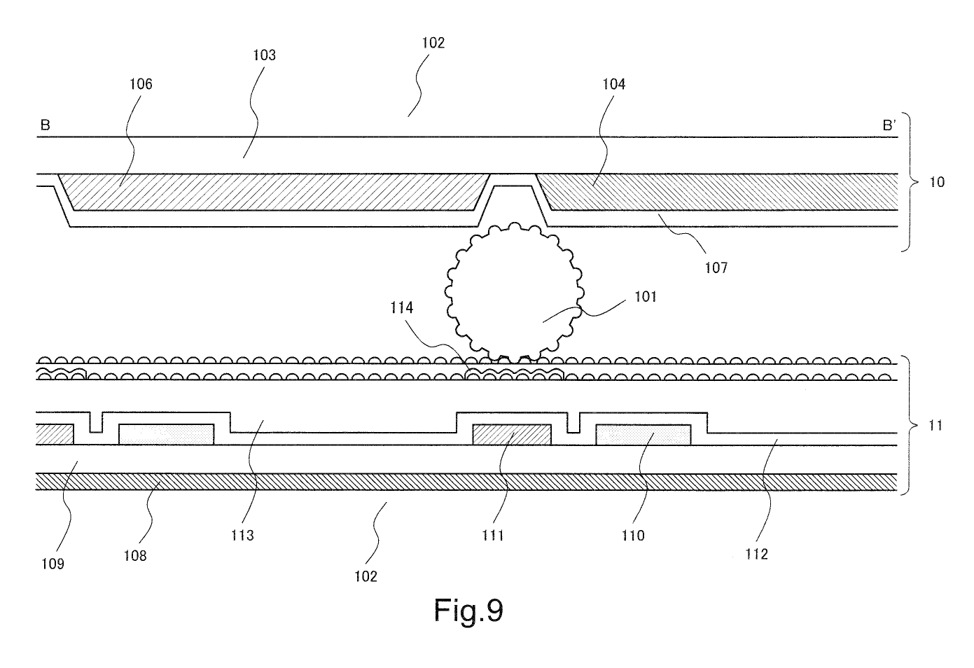

An LCD panel and a method for manufacturing thereof according to a second exemplary embodiment of the present invention will be described with reference to FIG. 8 and FIG. 9. FIG. 8 is a plan view showing a structure of the CF substrate 11 of the embodiment, and FIG. 9 is a cross sectional view showing a structure of the LCD panel taken along a line indicated as B-B′ in FIG. 8.

In FIG. 9, the spherical spacer 101 is arranged in a light shielding area arranged between the substrates and also between a blue display area and a red display area (area of a black matrix 103 between one of the color layers 106 and one of the color layers 104). As shown in FIG. 9, an area where the color layers are not formed includes a concave portion. It is possible to restrain the spherical spacer 101 from moving, if the spherical spacer 101 is arranged at the convex portion between two color layers.

The pixel electrodes 114 are arranged under a portion of the alignment film 107 corresponding to the concave portion of the TFT substrate 10. According to the LCD panel of the second exemplary embodiment, a process for roughening surface of the planarizing layer 113 is carried out before a process for patterning the pixel electrodes 114 and the opposed electrodes 115 (not appearing in the FIG. 9).

As shown in FIG. 9, when the pixel electrodes 114 and the opposed electrodes 115 are formed on the planarizing layer 113 which is roughened with the photolithography method, it is possible to make the pixel electrodes 114 and the alignment film 107 on which the spherical spacer is arranged rough.

According to the second exemplary embodiment, the spherical spacer 101 is arranged in the light shielding area arranged between a blue display area and a red display area (black matrix area between one of the color layers 106 and one of the color layers 104). Because the spherical spacer 101 is arranged at the light shielding area which is the farthest area from the green display area (color layers 105) with the highest visibility among the red, the green and the blue display areas, the display trouble may be reduced even if the spherical spacer 101 is placed in the display area by accident.

### The Third Exemplary Embodiment

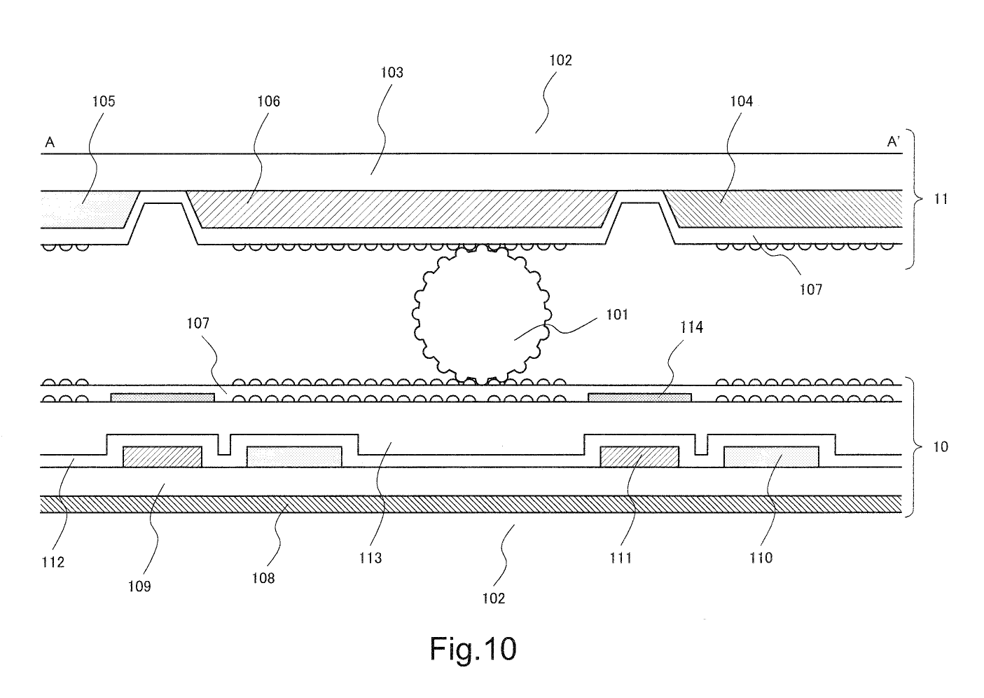

An LCD panel and a method for manufacturing thereof according to a third exemplary embodiment of the present invention will be described with reference to FIG. 10. FIG. 10 is a cross section view showing a structure of the LCD panel according to the embodiment. As shown in FIG. 10, a difference of the LCD panel and the method for manufacturing thereof according to the embodiment from ones according to the first exemplary embodiment is that the partial area of the CF substrate 11 having contact with a spherical spacer 101 is roughened.

It is possible to roughen the CF substrate 11 by exposing the CF substrate 11 in the He plasma atmosphere after forming the color layers 104 to 106 by using a surface of resin.

When not only the surface of the spherical spacer 101 and the partial area of the TFT substrate 10 having contact with the spherical spacer 101 but also the partial area of the CF substrate 11 having contact with the spherical spacer 101 are roughened, a large frictional force is generated between the spherical spacer 101 and both of the substrates. As a result, it is possible to further restrain the spherical spacer 101 from moving.

### The Fourth Exemplary Embodiment

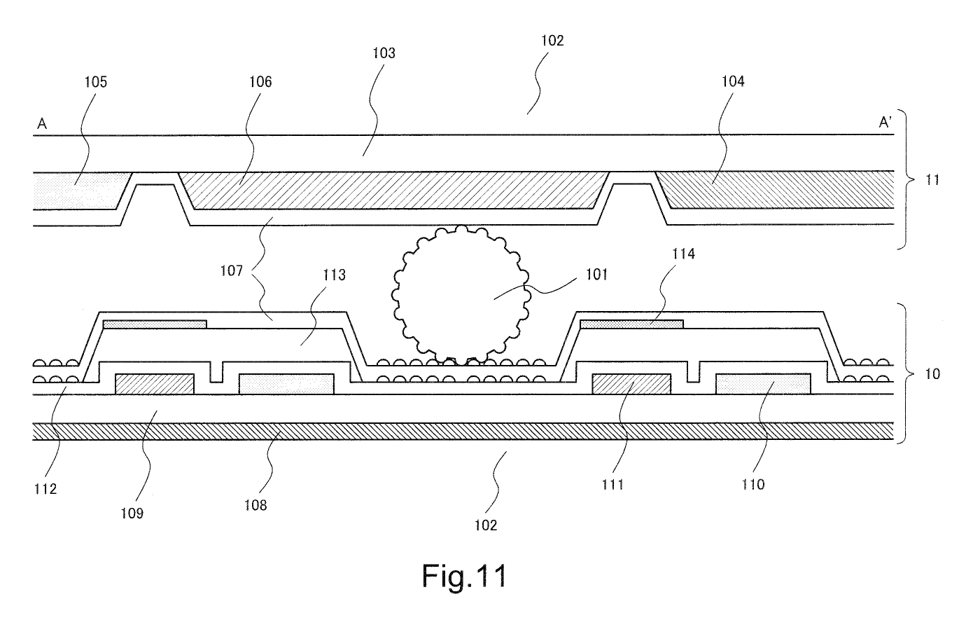

An LCD panel and a method for manufacturing thereof according to a fourth exemplary embodiment of the present invention will be described with reference to FIG. 11. FIG. 11 is a cross sectional view showing a structure of the LCD panel according to the embodiment. According to the fourth exemplary embodiment, as shown in FIG. 11, a planarizing layer 113 is formed in an island-shape so as to have a concave portion in which the spherical spacer 101 is arranged. The concave portion interposed between the planarizing layers 113 has a width longer than a diameter of the spherical spacer 101 and shorter than a width of a shielding area, and has a depth shorter than a diameter of the spherical spacer 101. A bottom surface of the concave portion, that is, a surface of the passivation film 112 on which the planarizing layer 113 is not formed is roughened.

The above-mentioned rough passivation film 112 and the island-shaped planalizing layer 113 are manufactured as follows That is, after forming the passivation film 112 with silicon nitride, surface of the passivation film 112 is roughened by exposing the passivation film 112 in the etching gas atmosphere. A photosensitive acrylic resin is formed on the passivation film 112, and then, the island-shaped planarizing layer 113 is formed with the photolithography method.

As mentioned above, when the spherical spacer 101 is arranged in the concave part formed with the island-shaped planalizing layer 113, it is possible to restrain the spherical spacer 101 from moving to the display area or the like and to provide the LCD panel which hardly causes the display trouble such as degradation of contrast.

While the island-shaped planarizing layer 113 is made of the photosensitive acrylic resin according to the fourth embodiment, the material of the planarizing layer 113 is not limited to such one. For example, an acrylic resin without photosensitivity, a styrene based resin and a novolac resin may be applicable to the planarizing layer 113.

The method for roughening surface of the passivation film 112 is not limited to the exposure to the etching gas atmosphere. For example, a method of dipping the passivating film 112 in hydrofluoric acid based solution after photolithographying the organic film may be applicable.

Moreover, while the concave portion has a width longer than a diameter of the spherical spacer 101 according to the fourth exemplary embodiment, a width of the concave portion is not limited to the above mentioned width. If the spherical spacer 101 comes in contact with the bottom of the concave part (passivation film 112 with roughened surface) and does not touch side of the concave portion when the spherical spacer 101 is arranged on the TFT substrate, the width of the concave portion may be applicable.

### The Fifth Exemplary Embodiment

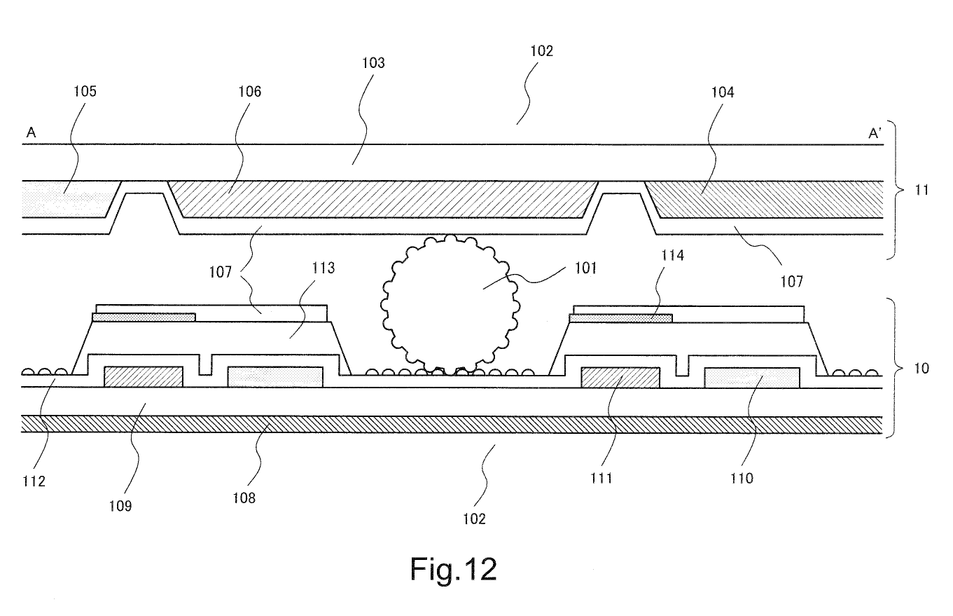

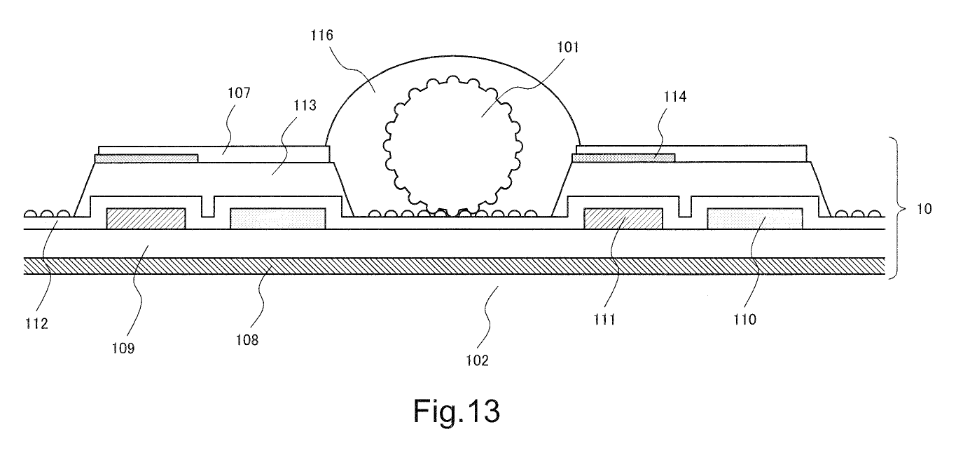

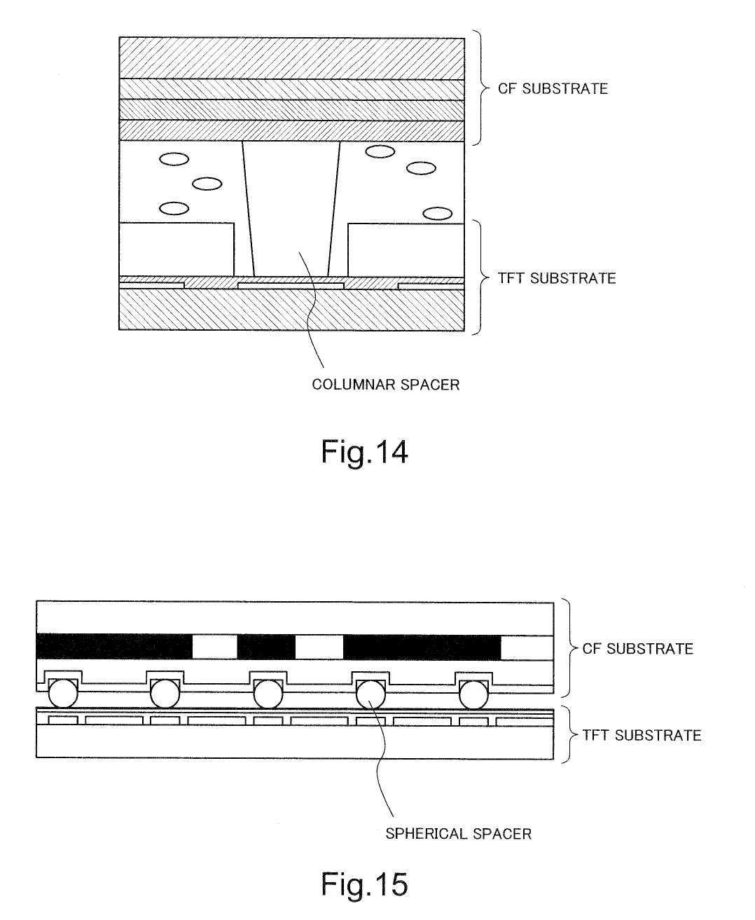

An LCD panel and a method for manufacturing thereof according to a fifth exemplary embodiment of the present invention will be described with reference to FIG. 12 and FIG. 13. FIG. 12 is cross sectional view showing a structure of an LCD panel according to the fifth exemplary embodiment and FIG. 13 is a fragmentary cross sectional view showing a manufacturing process of a TFT substrate 10 according to the fifth exemplary embodiment. In FIG. 12, the alignment film 107 made of polyimide is not formed at the partial area of the TFT substrate 10 having contact with a spherical spacer 101, a passivation film 112 made of a silicon nitride film is exposed in the contact area.

When the alignment film 107 is not formed at the partial area of the TFT substrate 10 having contact with the spherical spacer 101, surface roughness is not decreased by the alignment film 107. In other words, even if the surface roughness of the passivation film 112 is small, it is thoroughly possible to restrain the spherical spacer 101 from moving. It is possible to decrease a process time for roughening the passivation film 112 (process time of exposure to the etching gas atmosphere) in comparison with the fourth exemplary embodiment.

Moreover, while surface energy of the alignment film 107 made of polyimide is generally about 40 mJ/m², the surface energy of the passivation film 112 made of silicon nitride is about 70 mJ/m². So a wettability of the passivation film 112 is higher than that of the alignment film 107. When ink containing the spherical spacers is used for printing, printing on the passivation film 112 is much better at accuracy than printing on the alignment film 107. FIG. 13 shows the TFT substrate 10 on which a printing process is carried out by the ink containing the spherical spacer 101 with the ink jet method.

A method for printing the spherical spacer 101 is not limited to the ink jet method, the offset printing method is acceptable. The offset printing method can also provide equal effect due to difference of the wettability.

With regard to a method for arranging the alignment film 107 selectively, an unnecessary area of the alignment film 107, i.e. a polyimide film, is removed with laser beam. Moreover, there are other methods in addition to the method of removing the alignment film 107 with the laser beam, for example, a method of printing the alignment film 107 on a surface on which water-repellent process is carried out selectively, and a method of printing the alignment film 107 selectively with a printing method.

When the spherical spacers are arranged between the substrates based on structures disclosed in document 2 to 4 in the background art, following problems occur. That is, when the concave portion is formed in the CF substrate and the spherical spacer is arranged in the concave portion like the LCD panel disclosed in document 2, it is necessary to widen the concave portion to some extent in consideration of variation of size of the spherical spacer, manufacturing error and workability of arranging of the spherical spacer. Accordingly, it is difficult to restrain completely the spherical spacer from moving.

When only to either a surface of the spherical spacer or a surface of the substrate is roughened as the LCD panel disclosed in documents 3 and 4 is done, it is difficult to restrain substantially the spherical spacer from moving. Accordingly, when the spherical spacer moves to the display area, the contrast is degraded.

In contrast, according to the LCD panel and the method for manufacturing thereof according to the exemplary embodiments of the present invention, both a surface of the spherical spacer and a surface having contact with the spherical spacer of one of the substrates are roughened. Thus, it is possible to restrain substantially the spherical spacer from moving and to prevent degradation of contrast.

The frictional force which is generated when the surfaces of the spherical spacer 101 and at least either of the substrates are roughened can be increased several times as large as the frictional force which is generated when both the surfaces of the spherical spacer and the substrate are not roughened.

Accordingly, it is possible to provide the LCD panel and the method for manufacturing thereof which can prevent display trouble, for example, the luminance non-uniformity due to change of volume of the liquid crystal, and the black haze due to the compressive distortion. Moreover, it is possible to provide the LCD panel and the method for manufacturing thereof which can prevent degradation of contrast since the spherical spacer is restrained substantially from moving.

While the five exemplary embodiments are described above in detail, a specific structure is not limited to the exemplary embodiment described in detail. Any modification of the design within the scope of the invention is included in the invention.

Furthermore, while the bottom gate type TFT color display of IPS (In Plane Switching) mode which has a structure of interposition between the organic layers is applied to the LCD panel according to the five exemplary embodiments, LCD panel is not limited to the bottom gate type TFT color display. The LCD panel according to the present invention has no limitation in a structure of the TFT and the liquid crystal mode. An LCD panel with various modes such as TN (Twisted Nematic) mode and VA (Vertical Alignment) mode, and a monochrome LCD panel can be applicable.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A liquid crystal display panel, comprising:
a pair of substrates;
liquid crystal being arranged between said pair of substrates; and
spherical spacers being arranged between said pair of substrates;
wherein a partial area of at least one substrate of said pair of substrates is roughened, and
wherein each of said spherical spacers includes a plurality of projections on a surface thereof and is arranged on said roughened partial area.

2. The liquid crystal display panel according to claim 1, further comprising:
light shielding areas; and
display areas including a blue display area,
wherein said spherical spacers are arranged in said light shielding area which is adjacent to said blue display area.

3. The liquid crystal display panel according to claim 2,
wherein said display areas further including a green display area,
wherein said spherical spacers are arranged in said light shielding area which is the farthest to said green display area.

4. The liquid crystal display panel according to claim 1, wherein a roughness of surface of said spherical spacer defined by ten point height of roughness profile is not smaller than 50 nm and not larger than 5.5 percent of a diameter of said spherical spacer.

5. The liquid crystal display panel according to claim 1, wherein a roughness of surface of said roughened partial area defined by ten point height of roughness profile is not smaller than 50 nm and not larger than 5.5 percent of a diameter of said spherical spacer.

6. The liquid crystal display panel according to claim 1, wherein said pair of substrates includes a TFT (Thin Film Transistor) substrate and a CF (Color Filter) substrate, and wherein said TFT substrate includes a roughened layer of resin and an alignment film arranged on said layer of resin.

7. The liquid crystal display panel according to claim 6, further comprising:
a plurality of color layers arranged on said CF substrate, wherein said spherical spacers are arranged between said color layers.

8. The liquid crystal display panel according to claim 6, wherein a partial area of said CF substrate at least having contact with said spherical spacer is roughened.

9. The liquid crystal display panel according to claim 1, wherein said pair of substrates includes a TFT (Thin Film Transistor) substrate and a CF (Color Filter) substrate,
wherein said TFT substrate includes
a layer of resin forming a plurality of convex portions covered with an alignment film; and
a plurality of concave portions, each arranged between said convex portions and having a roughened bottom,
wherein said spherical spacers are arranged in said concave portion.

10. The liquid crystal display panel according to claim 9,
wherein a width of said concave portion is larger than a diameter of said spherical spacer, and a depth of said concave portion is shorter than said diameter of said spherical spacer.

11. The liquid crystal display panel according to claim 9, wherein said roughened bottom of concave portion is covered with said alignment film.

12. A method for manufacturing a liquid crystal panel in which liquid crystal and spherical spacers are arranged between a pair of substrates of a first substrate and a second substrate, comprising:
mixing a solution with said spherical spacers each having a plurality of projections;
exposing a partial area of a layer of resin formed on said first substrate in He plasma atmosphere for roughening a surface of said partial area;
applying said solution to said surface of said partial area having been roughened and evaporating said solution by heat; and
forming a sealing part on said first substrate and overlapping said second substrate on said first substrate while dropping said liquid crystal therebetween.

13. The method for manufacturing the liquid crystal display panel according to claim 12,
wherein said first substrate is a TFT (Thin Film Transistor) substrate and said second substrate is a CF (Color Filter) substrate having light shielding areas and display areas including a blue display area, and
wherein said partial area on said TFT substrate to be exposed for roughening in said exposing step corresponds to said light shielding area while is adjacent to said blue display area on said CF substrate when overlapped each other.
